(19) United States
(12) Patent Application Publication
(10) Pub. No.: US 2014/0340555 A1
(43) Pub. Date: Nov. 20, 2014

(54) IMAGE SENSING APPARATUS

(71) Applicant: CANON KABUSHIKI KAISHA, Tokyo (JP)

(72) Inventors: Masaaki Iwane, Sagamihara-shi (JP); Akira Okita, Yamato-shi (JP)

(73) Assignee: CANON KABUSHIKI KAISHA, Tokyo (JP)

(21) Appl. No.: 14/264,316

(22) Filed: Apr. 29, 2014

(30) Foreign Application Priority Data
May 14, 2013 (JP) 2013-102592

(51) Int. Cl. H04N 5/374

(52) U.S. Cl. CPC H04N 5/374
USPC 348/308

(57) ABSTRACT

An image sensing apparatus including a plurality of pixels arranged in a row direction and a column direction. Each pixel including a first photoelectric conversion element, a second photoelectric conversion element. A processing unit including a first capacitor and a second capacitor which are configured to hold a signal obtained by a signal of the first photoelectric conversion element and a signal of the second photoelectric conversion element. In a first image sensing mode, the processing unit holds an image sensing signal obtained by adding the signal of the first photoelectric conversion element and the signal of the second photoelectric conversion element in the second capacitor. In a second image sensing mode, the processing unit holds the added image sensing signal in a combined capacitance obtained by connecting the first capacitor and the second capacitor in parallel.

### BACKGROUND OF THE INVENTION

1. Field of the Invention

The present invention relates to an image sensing apparatus and, more particularly, to an image sensing apparatus capable of detecting image sensing signals and focus information signals.

2. Description of the Related Art

Image sensing apparatuses such as a CMOS image sensor are increasingly required to have a focus detection function for autofocus, which can detect not only image sensing signals but also focus information signals on an image sensing plane. Japanese Patent Laid-Open No. 2008-263352 discloses a CMOS image sensor having a focus detection function on an image sensing plane. Japanese Patent Laid-Open No. 2008-263352 discloses, as a CMOS image sensor, an image sensor in which focus information signal detection pixels for phase difference autofocus are arranged in a pixel unit.

However, since the conventional CMOS image sensor having the focus detection function on the image sensing plane uses some pixels for only detection of focus information signals, signals from the pixels cannot be used as image sensing signals. Therefore, the image sensing signals of that pixel portion are interpolated by the image sensing signals of surrounding pixels. This interpolation causes degradation in image sensing signals.

### SUMMARY OF THE INVENTION

The present invention improves the quality of image sensing signals obtained by using an image sensor having a focus detection function on its image sensing plane.

The first aspect of the present invention provides an image sensing apparatus comprising a pixel unit in which a plurality of pixels are arranged in a row direction and a column direction, each pixel including a first photoelectric conversion element, a second photoelectric conversion element, a charge-voltage converter, a transfer unit configured to transfer charges generated by the photoelectric conversion elements to the charge-voltage converter, and a reset unit configured to reset a voltage of the charge-voltage converter, column signal lines configured to provide signals from the pixel unit to a processing unit, the processing unit configured to process the signals from the pixel unit and a horizontal output line configured to output the signals from the processing unit, the processing unit including a first capacitor and a second capacitor which are configured to hold a signal obtained by adding a signal of the first photoelectric conversion element and a signal of the second photoelectric conversion element, and provided via the column signal line, wherein in a first image sensing mode, the processing unit holds an image sensing signal obtained by adding the signal of the first photoelectric conversion element and the signal of the second photoelectric conversion element in the second capacitor, and in a second image sensing mode, the processing unit holds the added image sensing signal in a combined capacitance obtained by connecting the first capacitor and the second capacitor in parallel.

The second aspect of the present invention provides an image sensing apparatus comprising a pixel unit in which a plurality of pixels are arranged in a row direction and a column direction, each pixel including a first photoelectric conversion element, a second photoelectric conversion element, a charge-voltage converter, a transfer unit configured to transfer charges generated by the photoelectric conversion elements to the charge-voltage converter, and a reset unit configured to reset a voltage of the charge-voltage converter, column signal lines configured to provide signals from the pixel unit to a processing unit; and the processing unit configured to process the signals from the pixel unit, wherein in a first image sensing mode, the processing unit A/D-converts the signal from the first photoelectric conversion element provided via the column signal line using a first counter, and A/D-converts the signal obtained by adding the signal from the first photoelectric conversion element and the signal from the second photoelectric conversion element provided via the column signal line using a second counter, and in a second image sensing mode, the processing unit A/D-converts the added signal using a counter formed by series-connecting the first counter and the second counter.

The third aspect of the present invention provides an image sensing apparatus comprising a pixel unit in which a plurality of pixels are arranged in a row direction and a column direction, each pixel including a first photoelectric conversion element, a second photoelectric conversion element, a charge-voltage converter, a transfer unit configured to transfer charges generated by the photoelectric conversion elements to the charge-voltage converter, and a reset unit configured to reset a voltage of the charge-voltage converter, column signal lines configured to provide signals from the pixel unit to a processing unit and the processing unit configured to process the signals from the pixel unit, wherein in the first image sensing mode, after the processing unit A/D-converts the signal from the first photoelectric conversion element provided via the column signal line using a first counter for counting, and stores a count value of the first counter in a second counter, the processing unit A/D-converts the signal obtained by adding the signal of the first photoelectric element and the signal of the second photoelectric element provided via the column signal line using the first counter from the count value in a direction opposite to that in the counting, and in a second image sensing mode, the processing unit A/D-converts the added signal using a counter formed by series-connecting the first counter and the second counter.

Further features of the present invention will become apparent from the following description of exemplary embodiments with reference to the attached drawings.

### BRIEF DESCRIPTION OF THE DRAWINGS

FIG. 1 is a block diagram showing an image sensing apparatus according to the present invention;

FIG. 2 is a circuit diagram showing a pixel unit according to the first embodiment;

FIG. 3 is a circuit diagram showing a column-readout circuit according to the first embodiment;

FIG. 4 is a view showing the layout of the column-readout circuits according to the first embodiment;

FIG. 5 is a timing chart in a mode in which focus detection is performed on an image sensing plane;

FIG. 6 is a timing chart in a mode in which no focus detection is performed on the image sensing plane;

FIG. 7 is a circuit diagram showing a column-readout circuit according to the second embodiment;

FIG. 8 is a timing chart in a mode in which focus detection is performed on an image sensing plane;

FIG. 9 is a timing chart in a mode in which no focus detection is performed on the image sensing plane;

FIG. 10 is a circuit diagram showing a column-readout circuit according to the third embodiment;

FIG. 11 is a timing chart in a mode in which focus detection is performed on an image sensing plane;

FIG. 12 is a timing chart in a mode in which no focus detection is performed on the image sensing plane; and

FIG. 13 is a circuit diagram showing a column-readout circuit according to the fourth embodiment.

### DESCRIPTION OF THE EMBODIMENTS

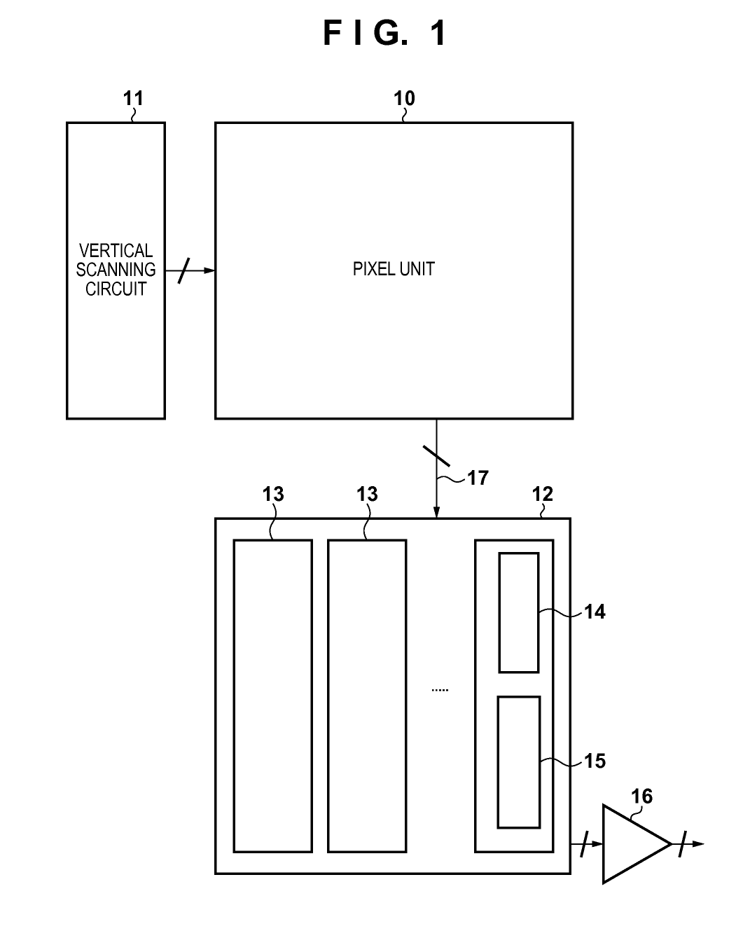

An image sensing apparatus according to the present invention will be described with reference to a block diagram shown in FIG. 1. The image sensing apparatus includes a pixel unit 10 in which pixels are arranged in a row and column directions, a vertical scanning circuit 11, a processing unit 12, column-readout circuits 13, an output circuit 16, and column signal lines 17. The vertical scanning circuit 11 performs scanning for each row or a plurality of rows of the pixel unit. Each column signal line 17 typically serves to transfer signals on one column of the pixel unit 10 to the corresponding column-readout circuit 13. When the vertical scanning circuit 11 scans each row, signals on one row are output from the pixel unit 10 to the column signal lines 17 arranged for the respective columns. The processing unit 12 includes at least the column-readout circuits 13 for all the columns and a horizontal transfer unit for transferring signals to an output circuit via horizontal output lines. The output circuit 16 is a circuit for outputting a signal. Each column-readout circuit 13 may include an A/D conversion circuit for converting an analog signal into a digital signal. Each column-readout circuit 13 includes a common readout circuit 14 and an image sensing signal readout circuit 15, which are used to read out a focus information signal or image sensing signal in accordance with an image sensing mode. The common readout circuit 14 is used in a first image sensing mode and a second image sensing mode. In the first image sensing mode, the common readout circuit 14 is used as a circuit for reading out a focus information signal, and the image sensing signal readout circuit 15 is used as a circuit for reading out an image sensing signal. In the second image sensing mode, the common readout circuit 14 is also used to read out an image sensing signal together with the image sensing signal readout circuit 15. Embodiments will be described below.

### First Embodiment

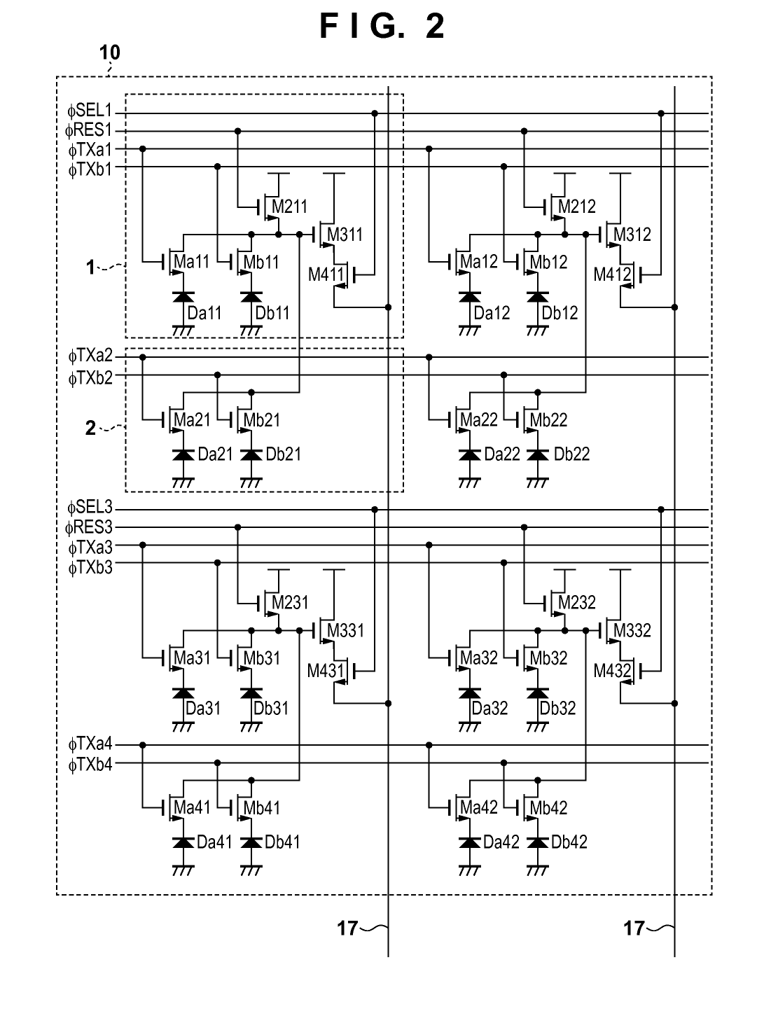

In this embodiment, a description will be made by assuming that analog image sensing signals and analog focus information signals are output intact. FIG. 2 is a circuit diagram showing details of pixels of 4 rows×2 columns of a pixel unit 10. The pixel unit 10 actually includes a number of pixels in the row and column directions, for example, pixels of 4,000 rows×6,000 columns. Each pixel of the pixel unit 10 according to this embodiment includes photoelectric conversion elements for converting light into an electrical signal. In each pixel, a first photoelectric conversion element and a second photoelectric conversion element are arranged. The photoelectric conversion element is, for example, a photodiode. As the first photoelectric conversion elements, A focus information signal photodiodes Da11 to Da42 are arranged. As the second photoelectric conversion elements, B focus information signal photodiodes Db11 to Db42 are arranged. Each pixel includes one microlens on the A focus information signal photodiode and the B focus information signal photodiode. That is, in each pixel, the first photoelectric conversion element and the second photoelectric conversion element are arranged on the right and left sides below one microlens. The first photoelectric conversion element and second photoelectric conversion element are used to detect an A focus information signal and B focus information signal, respectively. Therefore, the first photoelectric conversion element and second photoelectric conversion element can be paired to detect focus signals. Furthermore, both the signals are added and used as an image sensing signal. Since a focus information signal detection pixel and an image sensing signal detection pixel can have the same structure, degradation due to a difference in structure between the pixels hardly occurs in image sensing signals. Transfer transistors Ma11 to Mb42 are arranged as transfer units each of which transfers charges in the corresponding photoelectric conversion element to a charge-voltage converter. The pixel unit includes reset transistors M211 to M232 as reset units each of which resets the corresponding charge-voltage converter and the like. The charge-voltage converters convert the charges from the photoelectric conversion elements into electrical signals, and the electrical signals are amplified by amplification transistors M311 to M332. When selection transistors M411 to M432 are turned on, the outputs of the amplification transistors M311 to M332 are output to the corresponding column signal lines 17. Pulse signals φSEL1, φRES1, φTXa1, φTXb1, φTXa2, φTXb2, φSEL3, φRES3, φTXa3, φTXb3, φTXa4, and φTXb4 for controlling the pixel unit 10 and processing unit 12 are output from the vertical scanning circuit 11.

In the example shown in FIG. 2, pixel 1 is a pixel on the first row and the first column. Pixel 2 is a pixel on the second row and the first column. Pixels 1 and 2 which are vertically arranged share the reset transistor M211, amplification transistor M311, and selection transistor M411. The signal φSEL1 is used to select, via a selection line, the outputs of the amplification transistors M311 and M312 for amplifying the information signals of the pixel unit on the first and second rows, and the signal φRES1 is input to the reset transistors M211 via a reset line to reset the pixel unit on the first and second rows. The signal φTXa1 is input to the gate electrodes of the transfer transistors Ma11 and Ma12 for A focus information signals on the first row to control transfer of the A focus information signals. The signal φTXb1 is input to the gate electrodes of the transfer transistors Mb11 and Mb12 for B focus information signals on the first row to control transfer of the B focus information signals. Similarly, the signal φTXa2 is input to the gate electrodes of the transfer transistors Ma21 and Ma22 for A focus information signals on the second row to control transfer of the focus information signals. The signal φTXb2 is input to the gate electrodes of the transfer transistors Mb21 and Mb22 for B focus information signals on the second row to control transfer of the B focus information signals. Furthermore, the signal φSEL3 is used to select the outputs of the amplification transistors M331 and M332 on the third and fourth rows, and the signal RES3 is used to reset the pixels on the third and fourth rows. The signal φTXa3 is used to control transfer of A focus information signals on the third row, and the signal φTXb3 is used to control transfer of B focus information signals on the third row. Similarly, the signal φTXa4 is used to control transfer of A focus information signals on the fourth row, and the signal φTXb4 is used to control transfer of B focus information signals on the fourth row.

The charge-voltage converter adds the A focus information signal of the photodiode Da11 and the B focus information signal of the photodiode Db11 to obtain the image sensing signal of pixel 1. On the other hand, the shift between the strength peak of the A focus information signal group of the pixel unit 10 and that of the B focus information signal group of the pixel unit 10 serves as an index indicating how much a camera lens is out of focus. That is, if the position of the strength peak of the A focus information signal group coincides with that of the strength peak of the B focus information signal group, it indicates that the camera lens is focused on an object. Furthermore, for example, if the strength peak of the A focus information signal group is on the left side of a screen and the strength peak of the B focus information signal group is on the right side of the screen, it can be determined that the camera lens is in a front-focused state in which its focus position is in front of an image sensor. Alternatively, if the strength peak of the A focus information signal group is on the right side of the screen and the strength peak of the B focus information signal group is on the left side of the screen, it can be determined that the camera lens is in a rear-focused state in which its focus position is behind the image sensor.

Since a camera can calculate the movement amount of the camera lens for focusing based on the difference between the peak position of the A focus information signal and that of the B focus information signal, it is possible to perform autofocus.

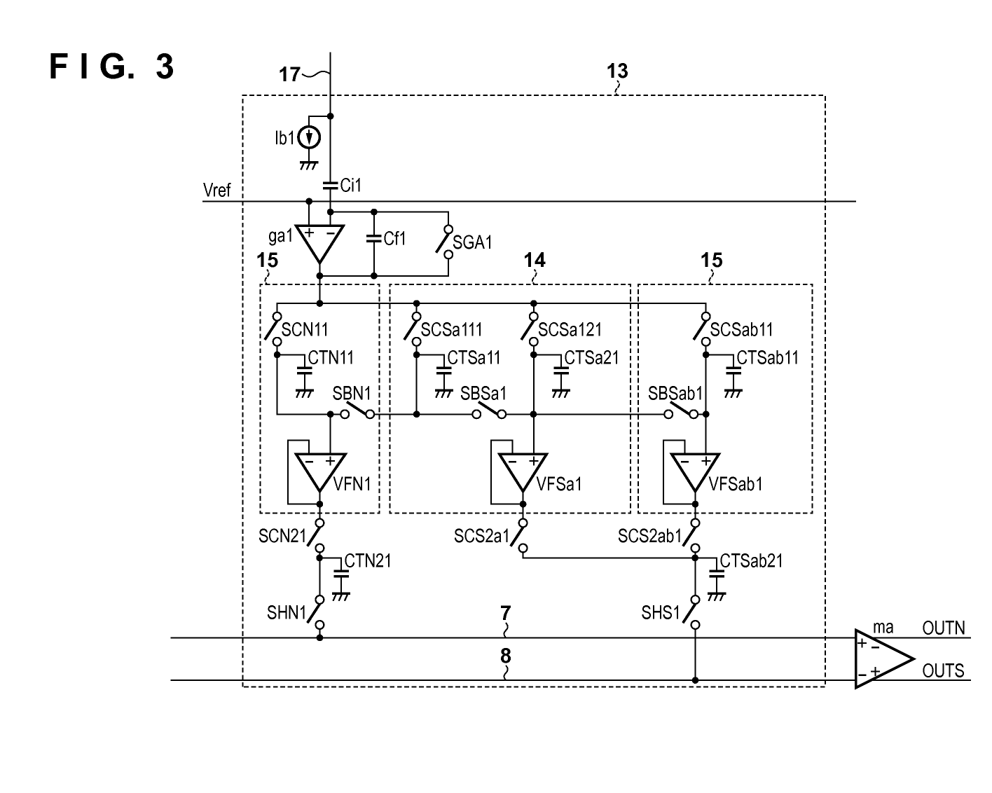

FIG. 3 shows an output amplifier ma and a column-readout circuit 13 of the processing unit 12 for pixel signals from the first pixel column according to the first embodiment. In FIG. 3, the output amplifier ma corresponds to the output circuit 16 of FIG. 1. The column-readout circuit 13 on the first pixel column will be described with reference to FIG. 3. The column-readout circuit 13 includes a column current source Ib1 connected to the column signal line 17, a gain amplifier ga1, and an input capacitor Ci1 and feedback capacitor Cf1 of the gain amplifier. The gain amplifier ga1 is an inverting amplifier circuit. Furthermore, the column-readout circuit 13 includes first, second, third, and fourth capacitors for holding signals read out from the pixel unit. In this embodiment, the first to fourth capacitors will be referred as a second analog memory CTSa21, luminance signal analog memory CTSab11, reset signal analog memory CTN11, and first analog memory CTSa11, respectively. Furthermore, a reset signal transfer buffer VFN1, focus information signal transfer buffer VFSa1, and luminance signal transfer buffer VFSab1 are arranged. In addition, an analog memory CTN21, analog memory CTSab21, and analog switches SGA1 to SHS1 are arranged.

Note that the first analog memory CTSa11, second analog memory CTSa21, and focus information signal transfer buffer VFSa1 are circuits belonging to the common readout circuit 14. Also, the reset signal analog memory CTN11, luminance signal analog memory CTSab11, reset signal transfer buffer VFN1, and luminance signal transfer buffer VFSab1 are circuits belonging to the image sensing signal readout circuit 15.

As described above, in the first image sensing mode, the common readout circuit 14 is used as a “read-only” circuit for a focus information signal, and the image sensing signal readout circuit 15 is used as a “read-only” circuit for an image sensing signal. On the other hand, in the second image sensing mode, part of the common readout circuit 14 is used for an image sensing signal. In this embodiment, when reading out only an image sensing signal in the second image sensing mode, the first analog memory CTSa11 is connected in parallel to the reset signal analog memory CTN11 to serve as an additional capacitor. The second analog memory CTSa21 is connected in parallel to the luminance signal analog memory CTSab11 to serve as an additional capacitor. It is possible to make a combined capacitance large by parallel connection. As a result, a signal transfer gain becomes large, thereby allowing reduction of the influence of noise. Performing an operation of reading out only an image sensing signal within a horizontal scanning period over a frame is advantageous in increasing the S/N of a still image or the like. In the second image sensing mode, since no autofocus is performed on the image sensing plane, shooting is performed using an additionally provided focus system.

To equalize the transfer gains of signal paths, the capacitance value of the reset signal analog memory CTN11 and that of the luminance signal analog memory CTSab11 are desirably equal to each other by including parasitic capacitances. To equalize the transfer gains when used in the second image sensing mode, the capacitance value of the first analog memory CTSa11 and that of the second analog memory CTSa21 are made equal to each other. To equalize the transfer gains of a focus signal and image sensing signal, the total capacitance value of the two capacitors is desirably equal to that of the luminance signal analog memory CTSab11.

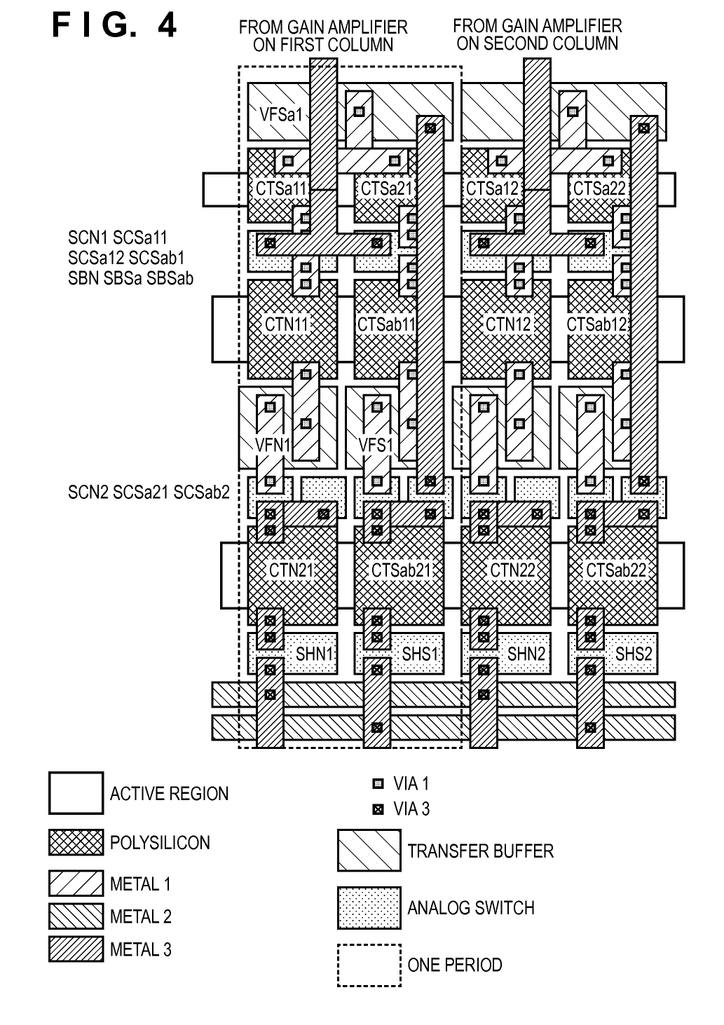

FIG. 4 is a view showing a layout corresponding to the circuit diagram shown in FIG. 3. Referring to FIG. 4, the above-described reference symbols denote the same parts. As shown in FIG. 4, a reset signal readout system (CTN11 and VFN1) and a luminance signal readout system (CTSab11 and VFS1) are formed in the similar or same electrode shape, and arranged. Therefore, it may be considered that the same disturbance noise is superimposed in the reset signal readout system (CTN11 and VFN1) and the luminance signal readout system (CTSab11 and VFS1). Therefore, the output amplifier ma of the succeeding stage can remove the disturbance noise by subtracting the signal of the reset signal readout system from that of the luminance signal readout system (CTSab11 and VFS1). On the other hand, a focus signal readout system (CTSa21, CTSa11, and VFSa1) has a layout in a shape different from that of the reset signal readout system (CTN11 and VFN1) or the luminance signal readout system (CTSab11 and VFS1), and disturbance noise is readily superimposed. This layout arrangement emphasizes the S/N of an image sensing signal rather than that of a focus information signal.

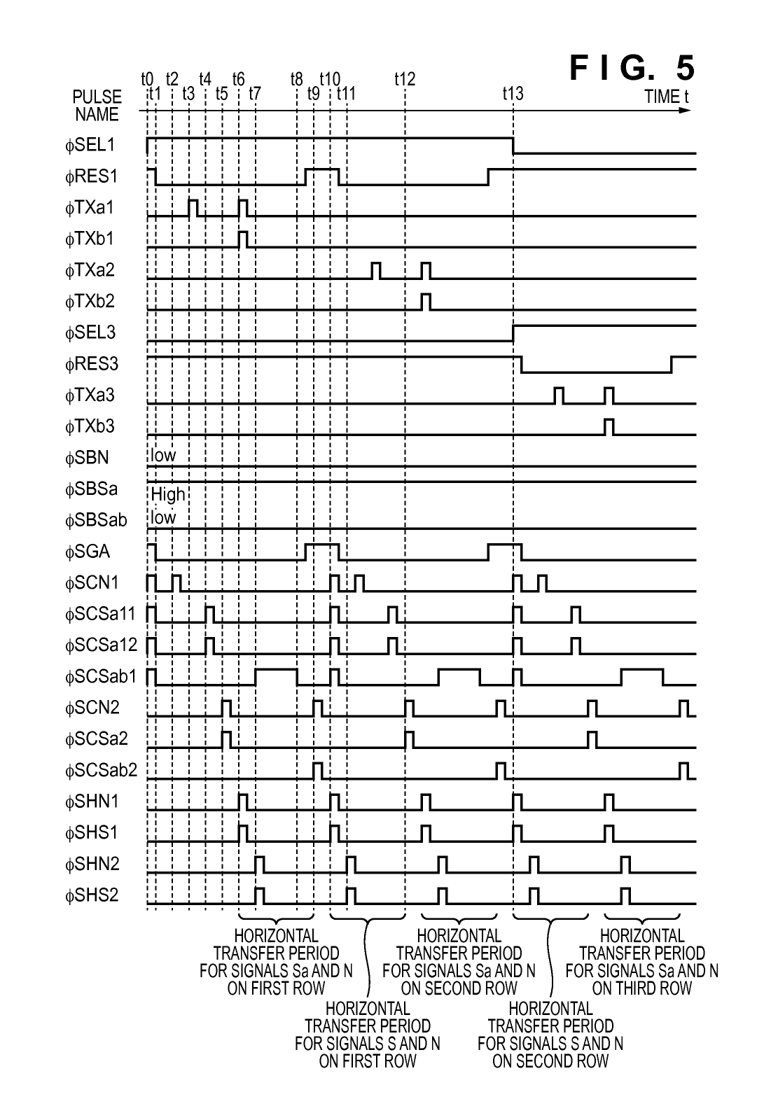

An operation when reading out an image sensing signal and focus information signal within one horizontal scanning period, that is, an operation in the first image sensing mode in which focus detection is performed on the image sensing plane will be described with reference to a timing chart shown in FIG. 5. In this mode, the pulse signals φSBN and φSBSab are always at low level, and the switches SBN1 and SBSab1 connected to the reset signal transfer buffer VFN1 and luminance signal transfer buffer VFSab1 are non-conductive. On the other hand, the pulse signal φSBSa is always at high level, and the switch SBSa1 is conductive. The first analog memory CTSa11 and second analog memory CTSa21 are connected in parallel by the switch SBSa1. At time t0, the vertical scanning circuit 11 outputs a signal which sets the signals φSEL1 and φRES1 at high level, the selection transistors M411 and M412 are turned on to select the first row of the pixel unit 10, and the reset transistors M211 and M212 are also turned on to reset the pixels. At this time, the voltages of diffusion capacitance nodes are also reset. The diffusion capacitance nodes are nodes at which the gate electrodes of the amplification transistors M311 and M312 and the source electrodes of the reset transistors M211 and M212 are respectively connected. The diffusion capacitance nodes are floating diffusion units serving as charge-voltage converters each of which converts charges output from the photodiode of the photoelectric conversion element into a voltage. At time t0, the vertical scanning circuit 11 also outputs a signal which sets the signal φSGA at high level, and the gain amplifier ga1 is set to a voltage follower state with respect to a reference voltage Vref. Furthermore, since the signals φSCN1, φSCSa11, φSCSa12, and φSCSab1 are set at high level, the switches SCN11, SCSa111, SCSa121, and SCSab11 are turned on. As a result, the reference voltage Vref is written in the analog memories CTN11, CTSa11, CTSa21, and CTSab11 to perform a reset operation.

At time t1, the vertical scanning circuit 11 outputs a signal which sets the signal φRES1 at low level to turn off the reset transistors M211 and M212, and the diffusion capacitance nodes are set in a floating state, thereby entering a state in which it is possible to read out reset signals N from the diffusion capacitance nodes. The voltage of each diffusion capacitance node is set to a reset voltage when the reset transistor is turned on by the signal φRES1 at time t0. In this state, the reset signals N of the diffusion capacitance nodes, which have been amplified by the amplification transistors M311 and M312 driven by the column current sources Ib1, are output to the corresponding column signal lines 17. The reset signals N are provided from the diffusion capacitance nodes to the gain amplifiers ga1 via the column signal lines 17, respectively. At time t1, the signal φSGA is at low level, and the gain amplifiers ga1 are set in an amplification mode in which an amplification factor is Ci1/Cf1. Furthermore, at the same time, the signals φSCN1, φSCSa11, φSCSa12, and φSCSab1 change to low level to turn off the switches SCN11, SCSa111, SCSa121, and SCSab11. As a result, the reset of the analog memories CTN11, CNSa11, CNSa21, and CNSab11 ends.

At time t2, the signal φSCN1 is set at high level to turn on the switch SCN11, and the output of the gain amplifier ga1 arranged for each column is written in the analog memory CTN11. At this time, the reset signal N is written in the analog memory CTN11, and includes an offset component mainly generated when the gain amplifier ga1 is reset. At time t3, the vertical scanning circuit 11 outputs a signal which sets the signal φTXa1 at high level to turn on the transfer transistors Ma11 and Ma12 on the first row, and charges accumulated in the photodiodes Da11 and Da12 for detecting the A focus information signals are transferred to the diffusion capacitance nodes. The voltages of the diffusion capacitance nodes drop, A focus information signals Sa are output to the corresponding column signal lines 17, and then A focus information is provided to the gain amplifiers ga1 via the column signal lines. At time t4, the signals φSCSa11 and φSCSa12 are set at high level, and the A focus information signal Sa amplified by the gain amplifier ga1 is written in the analog memories CTSa11 and CTSa21 which are connected in parallel.

At time t5, the signal φSCN2 is set at high level to turn on the switch SCN21, and the reset signal N is written from the analog memory CTN11 to the analog memory CTN21 via the buffer VFN1. At time t5, the signal φSCSa2 is simultaneously set at high level to turn on the switch SCS2a1, and the A focus information signal Sa is written from the analog memories CTSa11 and CTSa21 to the analog memory CTSab21 via the buffer VFSa1. According to the above-described readout operation, the reset signal N and A focus information signal Sa on each column of the first row are stored in the analog memories CTN21 and CTSab21 on each column.

At time t6, the signals φSHN1 and φSHS1 are set at high level to turn on the switches SHN1 and SHS1, thereby outputting the reset signal N in the analog memory CTN21 and the A focus information signal Sa in the analog memory CTSab21 to horizontal output lines 7 and 8, respectively. The horizontal output lines 7 and 8 include a reset signal horizontal signal line 7 and a luminance signal horizontal signal line 8. The output amplifier ma subtracts the reset signal N from the A focus information signal Sa, and outputs, from the image sensor via terminals OUTN and OUTS, an A focus information signal (Sa−N) for which an offset voltage generated in a signal path on the first row and the first column has been corrected. At time t7, the signals φSHN2 and φSHS2 for controlling transfer on the second column are set at high level, and the switches on the second column are controlled in the same manner as that for the first column to transfer the reset signal N and A focus information signal Sa on the second column to the reset signal horizontal signal line 7 and luminance signal horizontal signal line 8, respectively. The output amplifier ma subtracts the reset signal N from the A focus information signal Sa, and outputs, from the image sensor via the terminals OUTN and OUTS, an A focus information signal (Sa−N) for which the reset signal N on the first row and the second column has been removed. Signals on the next column are sequentially read out, and transfer to the horizontal output lines on the second column and subsequent columns also ends until time t9.

An operation of reading out a luminance signal Sab will be explained next. At time t6, the vertical scanning circuit 11 outputs a signal which sets the signals φTXa1 and φTXb1 at high level to turn on the transfer transistors Ma11 and Ma12 and the transfer transistors Mb11 and Mb12, respectively. As a result, charges accumulated in the photodiodes Db11 and Db12 for detecting B focus information signals are transferred to the diffusion capacitance nodes, and the charges of the B focus information signals and those of the A focus information signals which remain in the diffusion capacitance nodes are added. The voltage of each diffusion capacitance node drops, and a signal obtained by adding the A focus information signal Sa and the B focus information signal Sb appears as the luminance signal Sab in the corresponding column signal line 17. Since the luminance signal Sab is read out as the added signal, noise to be superimposed becomes relatively small, and a high S/N is obtained. At time t7, the signal φSCSab1 is set at high level to turn on the switch SCSab11, and the luminance signal Sab amplified by the gain amplifier ga1 arranged for each column is written in the analog memory CTSab11. At time t8, the signal φSCSab1 is set at low level to turn off the switch SCSab11, thereby terminating the operation of writing the luminance signal Sab in the analog memory CTSab11. At time t9, the signal φSCN2 is set at high level to turn on the switch SCN21, and the reset signal N is written again from the analog memory CTN11 to the analog memory CTN21 via the buffer VFN1. At time t9, the signal φSCSab2 is simultaneously set at high level to turn on the switch SCS2ab1, and the luminance signal Sab is written from the analog memory CTSab11 to the analog memory CTSab21 via the buffer VFSab1. During a period from time t6 to time t9, the luminance signal Sab is written in the analog memory CTSab11 on each column while transferring the A focus information signal Sa and reset signal N on each column to the horizontal output lines. It is, therefore, possible to shorten one horizontal scanning period while obtaining autofocus information. Consequently, it is also possible to increase the frame rate.

At time t10, the signals φSHN1 and φSHS1 are set at high level to turn on the switches SHN1 and SHS1. As a result, the reset signal N in the analog memory CTN21 and the luminance signal Sab in the analog memory CTSab21 are transferred to the reset signal horizontal signal line 7 and luminance signal horizontal signal line 8, respectively. The output amplifier ma subtracts the reset signal N from the luminance signal Sab, and outputs, from the image sensor via the terminals OUTN and OUTS, a luminance signal (Sab−N) for which an offset voltage generated in the signal path on the first row and the first column has been corrected, that is, an image sensing signal. At this time, the luminance signal (Sab−N) and the A focus information signal (Sa−N) on the first row and the first column are obtained. A subtraction processing unit is also provided to obtain the B focus information signal Sb by performing subtraction processing for the obtained luminance signal (Sab−N) and A focus information signal (Sa−N).

At time t10, while the signal φSEL1 is at high level, the selection transistors M411 and M412 are kept ON. During this period, the signal φTXa2 is set at high level and the transistors Ma21 and Ma22 are turned on, thereby reading out A focus information signals on the second row, and subsequently reading out luminance signals on the second row, similarly to the first row of the pixel unit 10. At time t11, the signals φSHN2 and φSHS2 are set at high level to turn on the switches SHN2 and SHS2 (shown in FIG. 4) arranged in the readout circuit of the pixel on the second column. As a result, the reset signal N and luminance signal Sab are transferred from the analog memories storing signals from the pixel on the first row and the second column to the reset signal horizontal signal line 7 and luminance signal horizontal signal line 8, respectively. After that, signals on the next column are sequentially read out to the horizontal output lines. At time t12, a transfer operation for the second column and subsequent columns also ends. At time t13, the vertical scanning circuit 11 sends a signal which sets the signal φSEL1 at low level, and the selection transistors M411 and M412 are turned off to set the second row of the pixel unit 10 in an unselected state, thereby terminating the readout operation for the second row. Subsequently, the signal φSEL3 is controlled to perform a readout operation for the third row and subsequent rows. After that, a readout operation is sequentially performed for the respective rows.

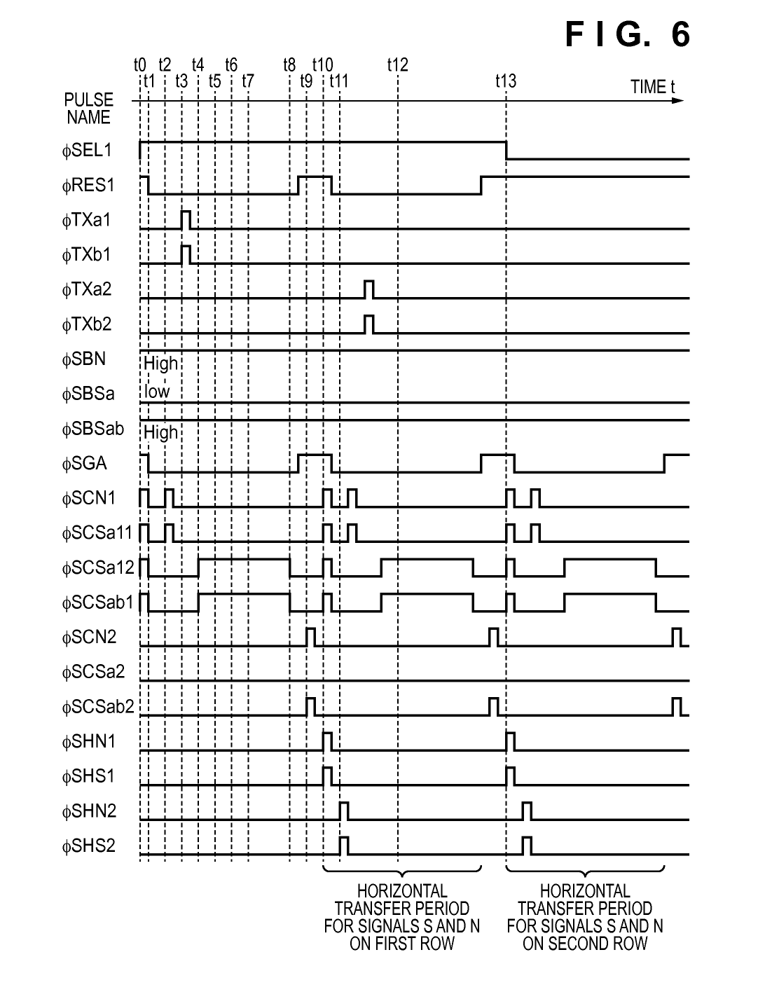

FIG. 6 is a timing chart in the second image sensing mode in which only an image sensing signal is read out within one horizontal scanning period. In this mode, the pulse signals ISBN and φSBSab of the switches SBN1 and SBSab1 are always at high level, and the switches are conductive. On the other hand, the signal φSBSa is always at low level, and thus the switch SBSa1 is non-conductive. As a result, the analog memory CTSa21 is connected in parallel to the luminance signal analog memory CTSab11 and, therefore, the combined capacitance increases. Since the analog memory CTSa11 is also connected in parallel to the reset signal analog memory CTN11, the combined capacitance increases. A description of portions redundant to the first image sensing mode will be omitted below.

At time t0, the vertical scanning circuit 11 sends a signal which sets the signals φSEL1 and φRES1 at high level to turn on the selection transistors M411 and M412, thereby selecting the first row of the pixel unit 10 and resetting the pixels on the first row. At time t1, the vertical scanning circuit 11 sends a signal which sets the signal φRES1 at low level to turn off the reset transistors M211 and M212, and the diffusion capacitance nodes are set in a floating state, thereby entering a state in which it is possible to read out the reset signals N. In this state, the reset signals N of the diffusion capacitance nodes, which have been amplified by the amplification transistors M311 and M312 driven by the column current sources Ib1, appear in the corresponding column signal lines 17. At time t1, the signal φSGA is set at low level, and the gain amplifiers ga1 are set in an amplification mode in which an amplification factor is Ci1/Cf1.

At time t2, the signals φSCN1 and φSCSa11 are set at high level to turn on the switches SCN11 and SCSa111, and the reset signal N amplified by the gain amplifier ga1 arranged for each column is written in the analog memories CTN11 and CTSa11 which are connected in parallel. At time t3, the signals φSCN1 and φSCSa11 are set at low level to turn off the switches SCN11 and SCSa111. The vertical scanning circuit 11 sends a signal which sets the signals φTXa1 and φTXb1 at high level, and the transfer transistors Ma11, Ma12, Mb11, and Mb12 are turned on, thereby transferring charges accumulated in the photodiodes Da11, Da12, Db11, and Db12 to the diffusion capacitance nodes, respectively. The voltages of the diffusion capacitance nodes drop, and luminance signals Sab appear in the corresponding column signal lines 17. At time t4, the signals φSCSa12 and φSCSab1 are set at high level, and the luminance signal Sab amplified by the gain amplifier ga1 is written in the analog memories CTSa21 and CTSab11 which are connected in parallel. At time t8, the signals φSCSa12 and φSCSab1 are set at low level to turn off the switches SCSa121 and SCSab11, thereby terminating the operation of writing the luminance signal Sab in the analog memories CTSa21 and CTSab11.

At time t9, the signal φSCN2 is set at high level to turn on the switch SCN21, and the reset signal N is written from the analog memories CTN11 and CTSa11 to the analog memory CTN21 via the buffer VFN1. At time t9, the signal φSCSab2 is simultaneously set at high level to turn on the switch SCS2ab1, and the luminance signal Sab is written from the analog memories CTSa21 and CTSab11 to the analog memory CTSab21 via the buffer VFSab1.

At time t10, the signals φSHN1 and φSHS1 are set at high level to turn on the switches SHN1 and SHS1. As a result, the reset signal N in the analog memory CTN21 and the luminance signal Sab in the analog memory CTSab21 are transferred to the reset signal horizontal signal line 7 and luminance signal horizontal signal line 8, respectively. The output amplifier ma subtracts the reset signal N from the luminance signal Sab, and outputs, from the image sensor via the terminals OUTN and OUTS, a luminance signal (Sab−N) for which an offset voltage in the signal path on the first row and the first column has been corrected, that is, an image sensing signal.

Even after time t10, while the signal φSEL1 is at high level, the selection transistors M411 and M412 are kept ON. During this period, the signals φTXa2 and φTXb2 are controlled to select the second row of the pixel unit 10, thereby reading out luminance signals.

At time t11, the signals φSHN2 and φSHS2 are set at high level to turn on the switches SHN2 and SHS2 (shown in FIG. 4) arranged in the readout circuit of the pixel on the second column. As a result, the reset signal N and luminance signal on the second column are transferred to the reset signal horizontal signal line 7 and luminance signal horizontal signal line 8, respectively. Luminance signals on the second row are read out while outputting the reset signals N and luminance signals on the second column and subsequent columns to the horizontal signal lines.

At time t13, the vertical scanning circuit 11 sends a signal which sets the signal φSEL1 at low level, and the selection transistors M411 and M412 are turned off to set the second row of the pixel unit 10 in an unselected state, thereby terminating the readout operation for the second row. The above operation according to the timing chart outputs image sensing signals from the image sensor within one horizontal scanning period.

The above-described operation can improve the S/N by expanding the dynamic range of an image sensor for image sensing, which can detect focus information signals, when the image sensor is used for image sensing without detecting any focus information signal. The first embodiment has been explained by assuming that the buffers VFN1, VFSa1, and VFSab1 are implemented by voltage follower circuits. However, the buffers may be implemented by source follower circuits or amplifier circuits having a gain of x2 or the like. The switches SCN11, SCSab11, and the like are desirably analog switches each formed by combining an n-type MOS transistor and p-type MOS transistor, but may be switches each formed by only an n-type MOS transistor or p-type MOS transistor. Although a column amplifier is arranged for each column in the first embodiment, the present invention is not limited to this, and is applicable to any case in which a plurality of column amplifiers each arranged for a plurality of pixels are included.

### Second Embodiment

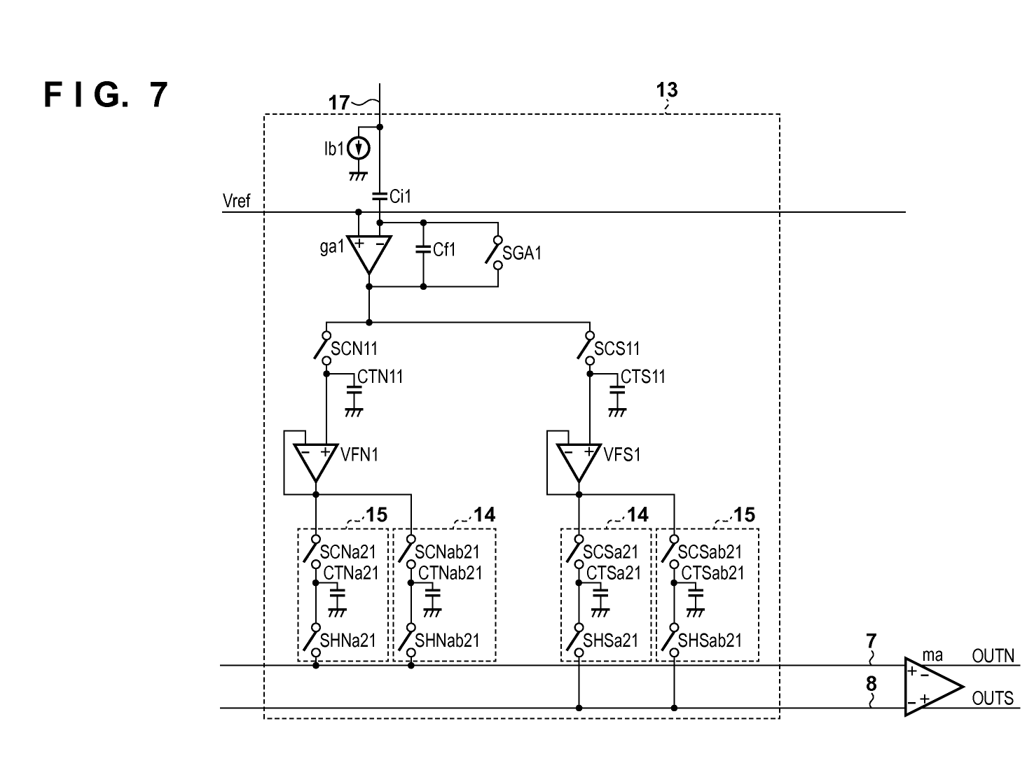

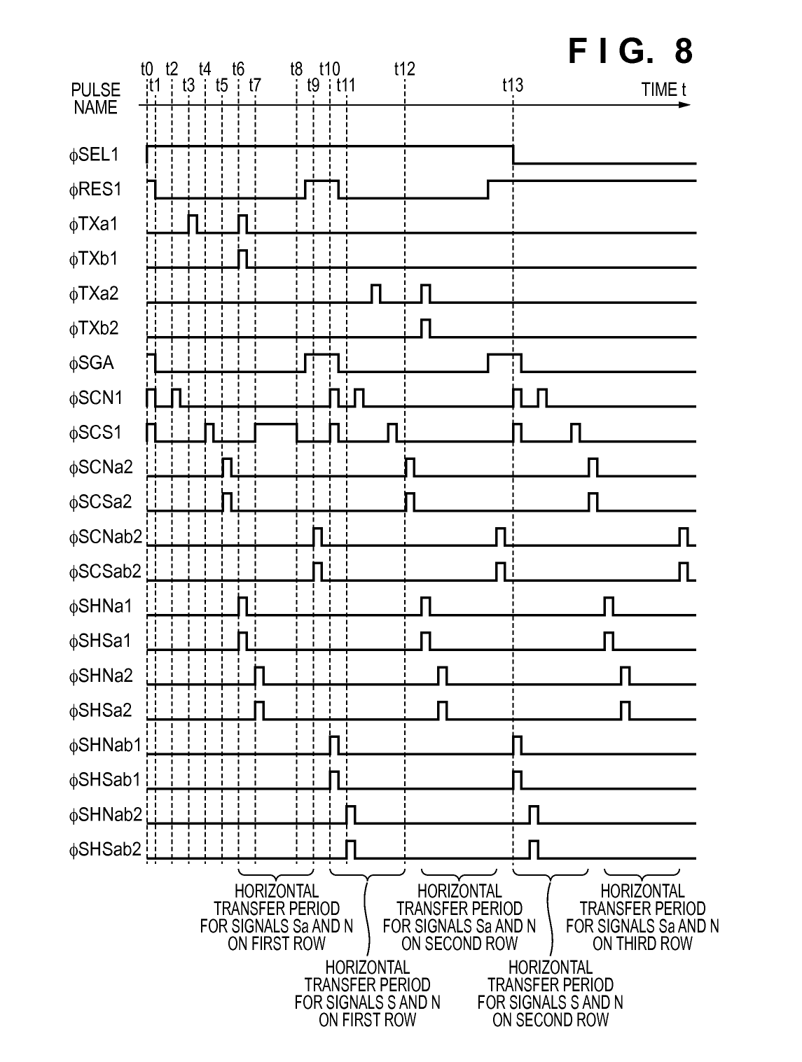

In this embodiment, an image sensor outputs an analog image sensing signal and analog focus information signal intact, similarly to the first embodiment. However, the arrangement of a column-readout circuit is different. A pixel unit 10 in this embodiment is the same as that in the first embodiment. The operation of the column-readout circuit according to the second embodiment will be described based on a circuit diagram shown in FIG. 7. A common readout circuit 14 includes analog memories CTNab21 and CTSa21 and switches SCNab21, SCSa21, SHNab21, and SHSa21. On the other hand, an image sensing signal readout circuit 15 includes analog memories CTNa21 and CTSab21 and switches SCNa21, SCSab21, SHNa21, and SHSab21. FIG. 8 is a timing chart in a mode in which autofocus is performed on an image sensing plane, that is, a first image sensing mode in which both an image sensing signal and a focus information signal are read out within one horizontal scanning period according to this embodiment. At time to, a vertical scanning circuit 11 outputs a signal which sets signals φSEL1 and φRES1 at high level, and selection transistors M411 and M412 are turned on to select the first row of the pixel unit 10. Furthermore, reset transistors M211 and M212 are turned on to reset pixels. At this time, the voltages of diffusion capacitance nodes are also reset.

At time t1, the vertical scanning circuit 11 sends a signal which sets the signal φRES1 at low level to turn off the reset transistors M211 and M212, and the diffusion capacitance nodes are set in a floating state, thereby entering a state in which it is possible to read out reset signals N. In this state, the reset signals N of the diffusion capacitance nodes, which have been amplified by amplification transistors M311 and M312 driven by column current sources Ib1, appear in corresponding column signal lines 17. At time t1, a signal φSGA is set at low level, and a gain amplifier ga1 is set in an amplification mode in which an amplification factor is Ci1/Cf1 to input signal from the column signal line 17.

At time t2, a signal φSCN1 is set at high level to turn on a switch SCN11, and the reset signal N amplified by the gain amplifier ga1 arranged for each column is written in an analog memory CTN11. After that, the signal φSCN1 changes to low level to turn off the switch SCN11. At time t3, the vertical scanning circuit 11 outputs a signal which sets a signal φTXa1 at high level to turn on transfer transistors Ma11 and Ma12 on the first row, and charges accumulated in photodiodes Da11 and Da12 are transferred to the diffusion capacitance nodes. The voltages of the diffusion capacitance nodes drop, and the voltages appear as A focus information signals Sa in the corresponding column signal lines 17. At time t4, a signal φSCS1 is set at high level to turn on a switch SCS11, and the A focus information signal Sa amplified by the gain amplifier ga1 is written in an analog memory CTS11.

At time t5, a signal φSCNa2 is set at high level to turn on the switch SCNa21, and the reset signal N is written from the analog memory CTN11 to the analog memory CTNa21 via a buffer VFN1. At time t5, a signal φSCSa2 is simultaneously set at high level to turn on the switch SCSa21, the A focus information signal Sa is written from the analog memory CTS11 to the analog memory CTSa21 via a buffer VFS1. At time t6, signals φSHNa1 and φSHSa1 change to high level to turn on the switches SHNa21 and SHSa21. The reset signal N in the analog memory CTNa21 and the A focus information signal Sa in the analog memory CTSa21 are transferred to a reset signal horizontal signal line 7 and luminance signal horizontal signal line 8 via the switches SHNa21 and SHSa21, respectively. An output amplifier ma subtracts the reset signal N from the A focus information signal Sa, and outputs, from the image sensor via terminals OUTN and OUTS, an A focus information signal (Sa−N) for which an offset voltage in a signal path on the first row and the first column has been corrected.

At time t6, the vertical scanning circuit 11 sends a signal which sets the signal φTXa1 and a signal φTXb1 at high level to turn on the transfer transistors Ma11 and Ma12 and transfer transistors Mb11 and Mb12, respectively. As a result, B focus information signal charges accumulated in photodiode Db11 and Db12 are transferred to the diffusion capacitance nodes, and the B focus information signals are added to the A focus information signals accumulated in the diffusion capacitance nodes. The voltage of each diffusion capacitance node drops, and a luminance signal Sab obtained by adding the A focus information signal Sa and a B focus information signal Sb appears in the column signal line 17. At time t7, the signal φSCS1 is set at high level to turn on the switch SCS11, and the luminance signal Sab amplified by the gain amplifier ga1 is written in the analog memory CTS11. At time t8, the signal φSCS1 is set at low level to turn off the switch SCS11, thereby terminating the operation of writing the luminance signal Sab in the analog memory CTS11. At time t7, signals φSHNa2 and φSHSa2 are set at high level, and the reset signal N and A focus information signal Sa from the pixel on the first row and the second column are transferred to the reset signal horizontal signal line 7 and luminance signal horizontal signal line 8, respectively. The output amplifier ma subtracts the reset signal N from the A focus information signal Sa, and outputs, from the image sensor via the terminals OUTN and OUTS, an A focus information signal (Sa−N) for which the reset signal on the first row and the second column has been removed.

The operation of transferring reset signals N and A focus information signals Sa on the second column and subsequent columns to the horizontal output lines also ends until time t9. At time t9, a signal φSCNab2 is set at high level to turn on the switch SCNab21, the reset signal N is written again from the analog memory CTN11 to the analog memory CTNab21 via the buffer VFN1. At time t9, a signal φSCSab2 is simultaneously set at high level to turn on the switch SCSab21, and the luminance signal Sab written at time t7is written from the analog memory CTS11 to the analog memory CTSab21 via the buffer VFS1. During a period from time t6 to time t9, the luminance signal Sab is written in the analog memory CTSab21 while transferring the A focus information signal (Sa−N) to the horizontal output lines. Therefore, it is possible to shorten one horizontal scanning period while obtaining focus information. Consequently, it is also possible to increase the frame rate.

At time t10, signals φSHNab1 and φSHSab1 are set at high level to turn on the switches SHNab21 and SHSab21. The reset signal N written in the analog memory CTNab21 and the luminance signal Sab written in the analog memory CTSab21 are transferred to the reset signal horizontal signal line 7 and luminance signal horizontal signal line 8, respectively. The output amplifier ma subtracts the reset signal N from the luminance signal Sab, and outputs, from the image sensor via the terminals OUTN and OUTS, a luminance signal (Sab−N), that is, an image sensing signal. At this time, the luminance signal (Sab−N) and the A focus information signal (Sa−N) on the first row and the first column are obtained. A subtraction processing unit is also provided to obtain the B focus information signal Sb by performing subtraction processing for the obtained signals.

At time t10, a signal which sets the signal φSEL1 at high level is continuously sent to keep the selection transistors M411 and M412 ON, and the second row of the pixel unit 10 is also selected and read out.

At time t11, signals φSHNab2 and φSHSab2 are set at high level to turn on readout switches on the first row and the second column. The reset signal N in the analog memory and the luminance signal Sab in the analog memory are transferred to the reset signal horizontal signal line 7 and luminance signal horizontal signal line 8, respectively.

The operation of transferring reset signals N and luminance signals Sab on the second column and subsequent columns to the horizontal output lines also ends until time t12. At time t13, the signal φSEL1 from the vertical scanning circuit 11 is set at low level to turn off the selection transistors M411 and M412, and the second row of the pixel unit 10 is set in an unselected state, thereby terminating the readout operation for the second row.

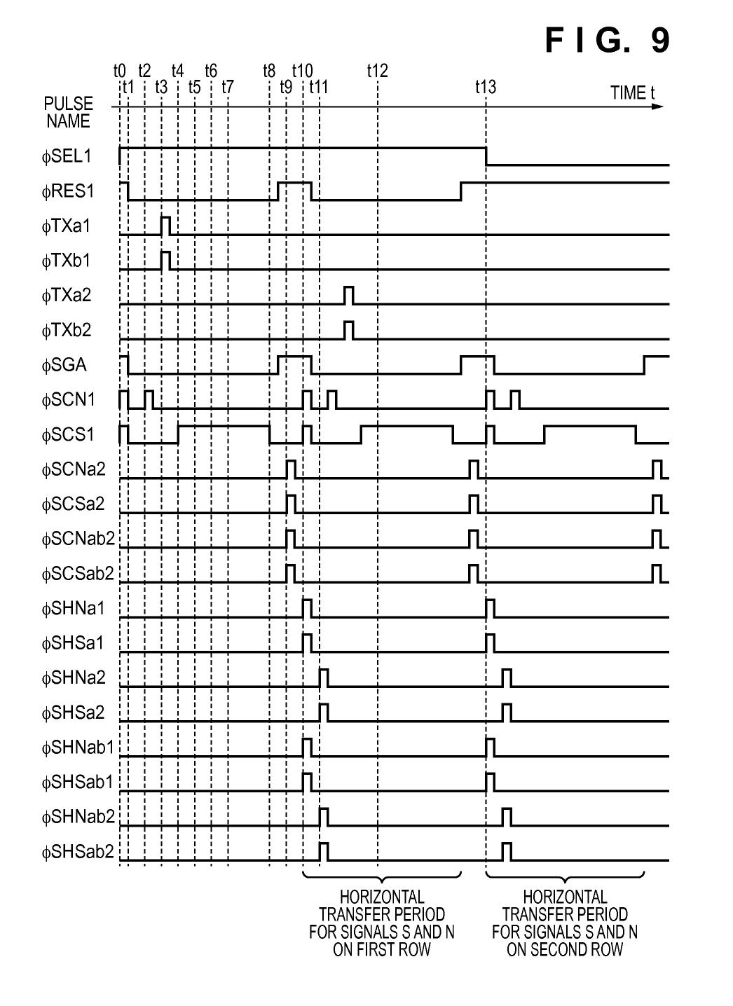

A second image sensing mode in which only an image sensing signal is read out within one horizontal scanning period will be described with reference to FIG. 9. At time t0, the vertical scanning circuit 11 sends a signal which sets the signals φSEL1 and φRES1 at high level to turn on the selection transistors M411 and M412, thereby selecting the first row of the pixel unit 10. Furthermore, the reset transistors M211 and M212 are turned on, and the pixel unit is reset by the signal φRES1.

At time t1, the vertical scanning circuit 11 sends a signal which sets the signal φRES1 at low level to turn off the reset transistors M211 and M212, and the diffusion capacitance nodes are set in a floating state, thereby entering a state in which it is possible to read out the reset signals N. In this state, the reset signals N of the diffusion capacitance nodes, which have been amplified by the amplification transistors M311 and M312 driven by the column current sources Ib1, appear in the corresponding column signal lines 17. At time t1, the signal φSGA is set at low level, and the gain amplifiers ga1 are set in an amplification mode in which an amplification factor is Ci1/Cf1 to input signal from the column signal lines 17.

At time t2, the signal φSCN1 is set at high level to turn on the switch SCN11, and the reset signal N amplified by the gain amplifier ga1 arranged for each column is written in the analog memory CTN11. After that, the signal φSCN1 changes to low level to turn off the switch SCN11. At time t3, the vertical scanning circuit 11 sends a signal which sets the signals φTXa1 and φTXb1 at high level, and the transfer transistors Ma11, Ma12, Mb11, and Mb12 are turned on. Electrons accumulated in the photodiodes Da11, Da12, Db11, Db12 are transferred to the diffusion capacitance nodes. The voltages of the diffusion capacitance nodes drop, and a luminance signal Sab based on the photodiodes Da11 and Db11 and that based on the photodiodes Da12 and Db12 appear in the respective column signal lines 17. At time t4, the signal φSCS11 is set at high level, and the luminance signal Sab is written in the analog memory CTS11 through the gain amplifier ga1. At time t8, the signal φSCS1 changes to low level to turn off the switch SCS11, thereby terminating the operation of writing the luminance signal Sab in the analog memory CTS11.

At time t9, the signals φSCNa2 and φSCNab2 are set at high level to turn on the switches SCNa21 and SCNab21, resulting in a state in which the analog memories CTNa21 and CTNab21 are connected in parallel. The reset signal N is written from the analog memory CTN11 to the combined capacitance of the analog memories CTNa21 and CTNab21 via the buffer VFN1. At time t9, the signals φSCSa2 and φSCSab2 are simultaneously set at high level to turn on the switches SCSa21 and SCSab21. As a result, the luminance signal Sab is written from the analog memory CTS11 via the buffer VFS1 to the analog memories CTSa21 and CTSab21 which are connected in parallel.

At time t10, the signals φSHNa1 and φSHNab1 are set at high level to turn on the switches SHNa21 and SHNab21, and the reset signal N written in the analog memories CTNa21 and CTNab21 is transferred to the reset signal horizontal signal line 7. At the same time, the signals φSHSa1 and φSHSab1 are set at high level to turn on the switches SHSa21 and SHSab21, and the luminance signal Sab written in the analog memories CTSa21 and CTSab21 is transferred to the luminance signal horizontal signal line 8. After that, the output amplifier ma subtracts the reset signal N from the luminance signal Sab, and outputs, from the image sensor via the terminals OUTN and OUTS, a luminance signal (Sab−N) for which an offset voltage in the signal path on the first row and the first column has been corrected, that is, an image sensing signal.

At time t10, a signal which turns on the signal φSEL1 at high level is continuously sent to keep the selection transistors M411 and M412 ON, thereby selecting the second row of the pixel unit 10.

At time t11, the signals φSHNa2 and φSHNab2 are set at high level to turn on the readout switches of the pixel on the first row and the second column, and the reset signal N is transferred to the reset signal horizontal signal line 7. At the same time, the signals φSHSa2 and φSHSab2 are set at high level to turn on the readout switches of the pixel on the first row and second column, and the luminance signal Sab is transferred to the luminance signal horizontal signal line 8.

At time t13, the vertical scanning circuit 11 sends a signal which sets the signal φSEL1 at low level to turn off the selection transistors M411 and M412, and the second row of the pixel unit 10 is set in an unselected state, thereby terminating the readout operation for the second row. The above operation according to the timing chart sequentially outputs image signals within one horizontal scanning period. According to this embodiment, it is possible to expand the dynamic range of an image sensing apparatus at the time of outputting an image sensing signal without detecting any focus signal using an image sensor capable of detecting a focus signal. In this embodiment, it is possible to reduce the number of buffer amplifiers of the circuit as compared with that in the second embodiment.

### Third Embodiment

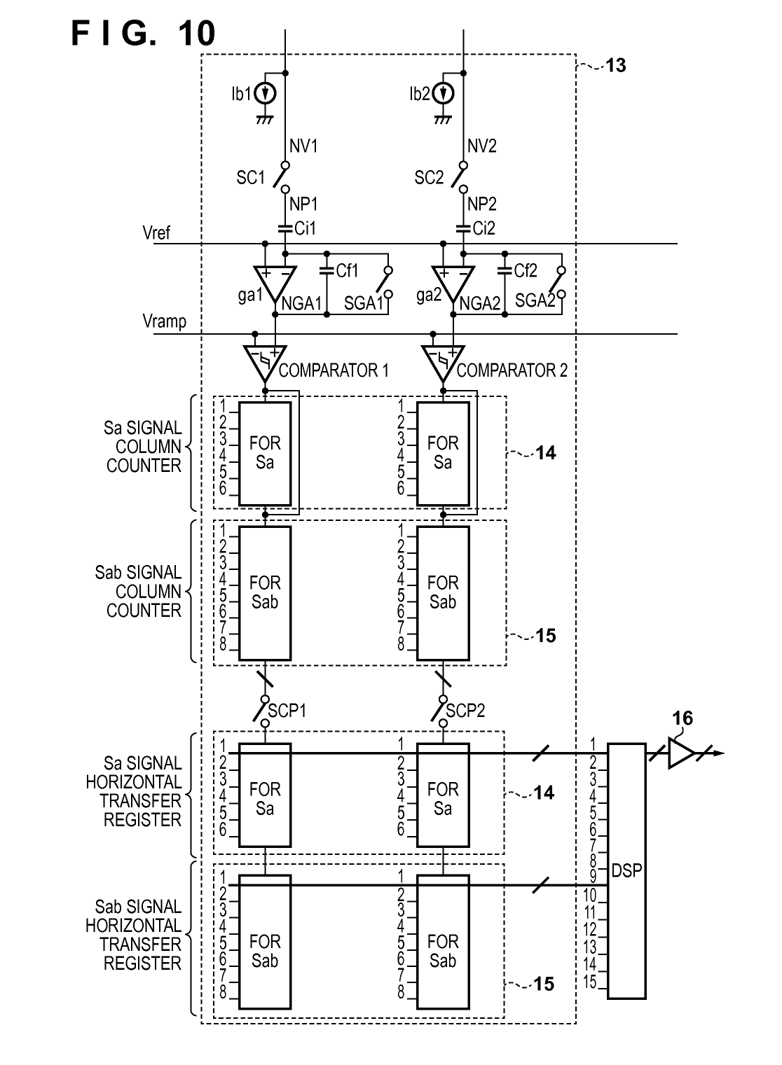

This embodiment is an example in which an A/D conversion circuit arranged for each column signal line converts an image sensing signal and a focus information signal into digital signals, and outputs them. In this embodiment, a pixel unit 10 is the same as that in the first embodiment but a column-readout circuit 13 is different from that in the first embodiment. The column-readout circuit of this embodiment will be described with reference to FIG. 10. The A/D conversion circuit is of a counter type, and includes a first counter and a second counter. In FIG. 10, reference symbols NV1 and NV2 denote column signal lines on the first and second columns, respectively; and NP1 and NP2, input nodes connected to input capacitors Ci1 and Ci2 on the first and second columns, respectively. A common readout circuit 14 includes an Sa signal column counter as a first counter, and an Sa signal horizontal transfer register. On the other hand, an image sensing signal readout circuit 15 includes an Sab signal column counter as a second counter, and an Sab signal horizontal transfer register.

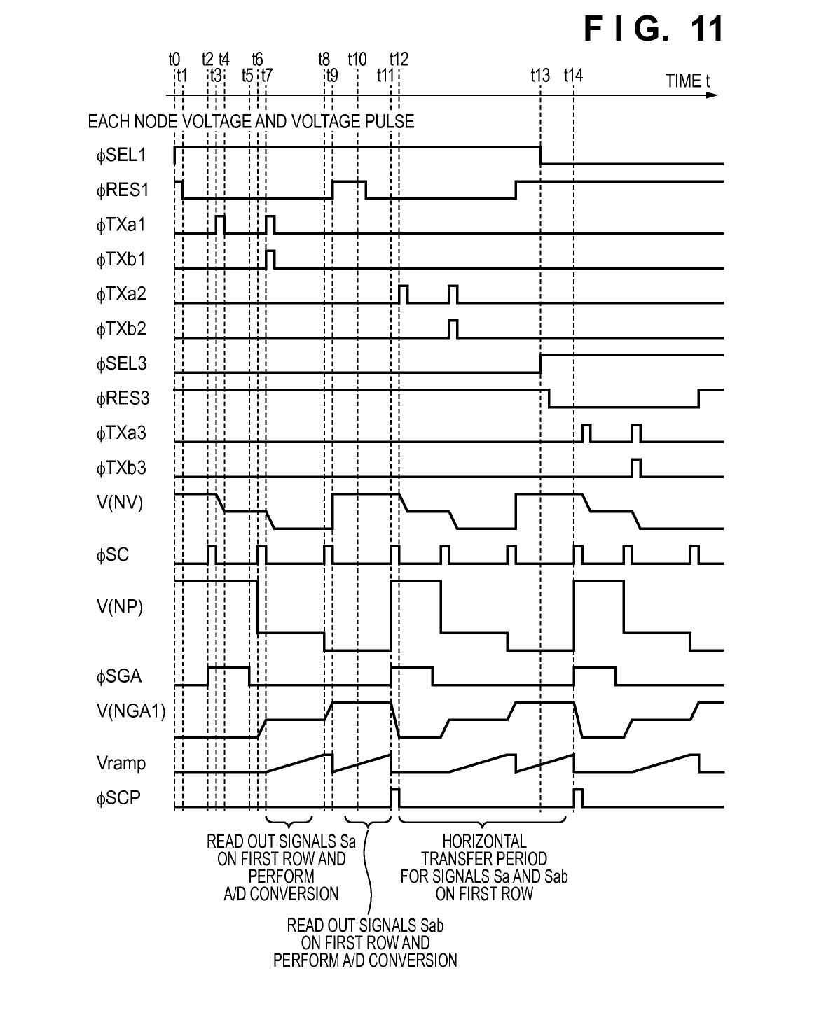

FIG. 11 is a timing chart in a first image sensing mode, that is, a mode in which an image signal and a focus information signal are read out within one horizontal scanning period according to this embodiment. Note that V(NV1) and the like respectively represent the voltage of a node NV1 and the like. At time to, a vertical scanning circuit 11 outputs a signal which sets signals φSEL1 and φRES1 at high level, and selection transistors M411 and M412 are turned on to select the first row of the pixel unit 10. Reset transistors M211 and M212 are also turned on to reset pixels. At time t1, the vertical scanning circuit 11 sends a signal which sets the signal φRES1 at low level to turn off the reset transistors M211 and M212, and diffusion capacitance nodes are set in a floating state, thereby entering a state in which it is possible to read out reset signals N. In this state, the reset signals N of the diffusion capacitance nodes, which have been amplified by amplification transistors M311 and M312 driven by column current sources Ib1, appear in corresponding column signal lines NV1 and NV2 as voltages V(NV1) and V(NV2). At time t2, a signal φSC is set at high level to turn on switches SC1 and SC2, and the voltages V(NV1) and V(NV2) of the column signal lines corresponding to the reset signals N are written in the nodes NP1 and NP2 as voltages V(NP1) and V(NP2). At the same time, a signal φSGA is set at high level, and gain amplifiers ga1 and ga2 are set in a voltage follower state, thereby writing a reference voltage Vref in nodes NGA1 and NGA2.

At time t3, the switches SC1 and SC2 are turned off and, at the same time, the vertical scanning circuit 11 sends a signal which sets a signal φTXa1 at high level to turn on transfer transistors Ma11 and Ma12. Charges accumulated in photodiodes Da11 and Da12 are transferred to the diffusion capacitance nodes. The voltages of the diffusion capacitance nodes drop, A focus information signals Sa appear in the column signal lines NV1 and NV2. At time t4, the transfer transistors Ma11 and Ma12 are turned off, thereby terminating the transfer operation.

At time t5, switches SGA1 and SGA2 are turned off and the gain amplifiers ga1 and ga2 are set in an amplification mode. At time t6, the switches SC1 and SC2 are turned on, and the A focus information signals Sa of the column signal lines NV1 and NV2 are written in the nodes NP1 and NP2 as the voltages V(NP1) and V(NP2), respectively. At this time, the gain amplifiers ga1 and ga2 amplify the A focus information signals Sa with Ci1/Cf1 and Ci2/Cf2, and output the amplified signals to the nodes NGA1 and NGA2, respectively. At time t7, when the voltages corresponding to the A focus information signals Sa of the nodes NGA1 and NGA2 become stable, and the gain amplifiers ga1 and ga2 terminate amplification. The A/D conversion circuit is of a counter type. When A/D conversion starts at time t7, a reference voltage Vramp for A/D conversion starts to rise. At the same time, the Sa signal column counter starts a count operation. Comparators 1 and 2 compare the voltages of the nodes NGA1 and NGA2 with the voltage Vramp. When the voltage Vramp exceeds the voltage of the node NGA1 or NGA2, comparator 1 or 2 outputs a signal to stop the Sa signal column counter. The count value of the Sa signal column counter at this time is set as the digital signal value of the A focus information signal Sa. At time t7, the vertical scanning circuit 11 sends a signal which sets the signal φTXa1 and a signal φTXb1 at high level to turn on the transfer transistors Ma11 and Ma12 and the transfer transistors Mb11 and Mb12, respectively. As a result, B focus information signal charges accumulated in the photodiodes Db11 and Db12 are transferred to the diffusion capacitance nodes, and added to the A focus information signal charges accumulated in the diffusion capacitance nodes. The voltages of the diffusion capacitance nodes drop, and luminance signals Sab obtained by adding the A focus information signals Sa and B focus information signals Sb appear in the column signal lines NV1 and NV2, respectively.

At time t8, the A/D conversion operation of the A focus information signal Sa on each column ends. Furthermore, the switches SC1 and SC2 are turned on, the luminance signals Sab of the column signal lines NV1 and NV2 are input to the nodes NP1 and Np2 as the voltages V(NP1) and V(NP2), and their amplified signals are output to the nodes NGA1 and NGA2. At time t9, voltages corresponding to the luminance signals Sab of the nodes NGA1 and NGA2 become stable, and amplification by the gain amplifiers ga1 and ga2 ends. Subsequently, A/D conversion starts. The reference voltage Vramp for A/D conversion rises. At the same time, the count operation of the Sab signal column counter starts. Comparators 1 and 2 compare the voltages of the nodes NGA1 and NGA2 with the voltage Vramp, respectively. When the voltage Vramp exceeds the voltage of the node NGA1 or NGA2, the node NGA1 or NGA2 outputs a signal to stop the Sab signal column counter. The count value of the Sab signal column counter at this time is set as the digital signal value of the luminance signal Sab.

At time t11, the A/D conversion operation of the luminance signal Sab on each column of the first row ends. At time t11, a signal φSCP is set at high level, and the digital values of the A focus information signals Sa stored in the Sa signal column counters and the digital values of the luminance signals Sab stored in the Sab signal column counters are transferred to the horizontal transfer registers.

At time t12, transfer of the A focus information signals Sa and luminance signals Sab on the first row from the horizontal transfer resisters to a digital signal processor (DSP) starts. The DSP, for example, corrects the digital signals, and sorts data to be output to the outside. The digital signals processed by the DSP are output using an output circuit 16 formed by an LVDS or the like. Time t10 indicates the time when selection of the second row of the pixel unit 10 starts. At this time, the signal φSEL1 remains at high level to keep the selection transistors M411 and M412 ON. The signals of pixels on the second row are read out using signals φTXa2 and φTXb2, similarly to the first row. Since A/D conversion is performed while transferring the signals on the first row to the DSP, it is possible to increase the speed of the readout operation. In the first image sensing mode of this embodiment, the bit width of A/D conversion can be set to, for example, 6 bits for the A focus information signals Sa and another bit width such as 8 bits for the luminance signals Sab. It is possible to provide a counter having a bit width required for a focus operation to a focus information signal, and provide a counter having a wide bit width to a luminance signal in consideration of image quality and the like.

At time t13, selection of the third row of the pixel unit 10 starts. Time t14 indicates the time when horizontal transfer of the A focus information signals Sa and luminance signals Sab on the first row to the DSP ends. In the third embodiment, the switches SC are used to simultaneously perform an operation of reading out signals from the pixel unit 10 and A/D conversion. It is, therefore, possible to increase the frame rate while obtaining focus information signals.

In this embodiment, at time t2, the reset signals N are accumulated in capacitors Ci1 and Ci2. If, therefore, the A focus information signals Sa are input to the nodes NP1 and NP2 at time t7, the input signals of the gain amplifiers are obtained by subtracting the reset signals N from the A focus information signals Sa, respectively. In this case, however, the offsets of the gain amplifiers ga1 and ga2 and comparators 1 and 2 may remain in the outputs of the respective columns. Therefore, after A/D conversion, the influence of the offsets may be removed by performing offset correction for the outputs of the respective columns.

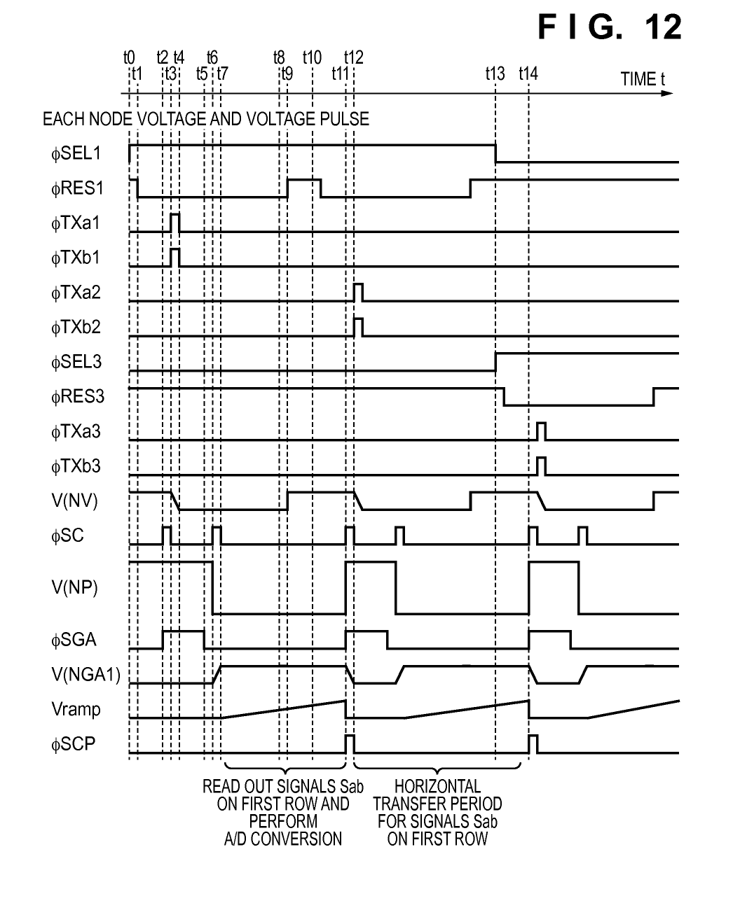

FIG. 12 is a timing chart in a mode in which only an image sensing signal is read out within one horizontal scanning period, that is, a second image sensing mode. In FIG. 12, the above-described reference symbols denote the same node voltages or voltage pulses. An operation up to when the signal φSC changes to high level to turn on the switches SC1 and SC2, and the voltages V(NV1) and V(NV2) of the column signal lines are output to the nodes NP1 and NP2 as the voltages V(NP1) and V(NP2) at time t2 is the same as that in the first image sensing mode, and a description thereof will be omitted.

At time t3, the switches SC1 and SC2 are turned off and, at the same time, the vertical scanning circuit 11 outputs a signal which sets the signals φTXa1 and φTXb1 at high level. Subsequently, the transfer transistors Ma11, Ma12, Mb11, and Mb12 are turned on, and charges accumulated in the photodiodes Da11, Da12, Db11, and Db12 are transferred to the diffusion capacitance nodes. The luminance signals Sab obtained by adding the A focus information signals Sa and B focus information signals Sb appear in the column signal lines NV1 and NV2, respectively. At time t4, the transfer transistors Ma11, Ma12, Mb11, and Mb12 are turned off, thereby terminating the operation of transferring the charges accumulated in the photodiodes Da11, Da12, Db11, and Db12 to the diffusion capacitance nodes.

At time t6, the switches SC1 and SC2 are turned on, and the luminance signals Sab of the column signal lines NV1 and NV2 are input to the nodes NP1 and NP2 as the voltages V(NP1) and V(NP2). At this time, the gain amplifiers ga1 and ga2 are in an amplification mode, and output the luminance signals Sab amplified with Ci1/Cf1 and Ci2/Cf2 from the nodes NGA1 and NGA2, respectively. At time t7, the output voltages of the nodes NGA1 and NGA2 become stable to terminate amplification by the gain amplifiers ga1 and ga2, thereby starting to raise the reference voltage Vramp for A/D conversion. At the same time, the Sa signal column counter and the Sab signal column counter are series-connected, the counters are operated in synchronism with each other to increase a bit width, thereby performing an A/D conversion operation. Comparators 1 and 2 compare the voltages of the nodes NGA1 and NGA2 with the reference voltage Vramp. When the reference voltage Vramp exceeds the voltage of the node NGA1 or NGA2, comparator 1 or 2 outputs a signal to stop the counters operating in synchronism with each other. The count value of the counter when the signal is output is set as the digital signal value of the luminance signal Sab. In the second image sensing mode, in order to expand the dynamic range of a still image or the like, A/D conversion is performed by operating the 6-bit Sa signal column counter and 8-bit Sab signal column counter in synchronism with each other to serve as a 14-bit synchronization counter. That is, the Sa signal column counter as part of the common readout circuit 14 for the focus information signal is used for A/D conversion of the image sensing signal to increase the bit width of the counter, thereby expanding the dynamic range.

At time t9, the reset transistors M211 and M212 are turned on, and the reset signals N are written again in the diffusion capacitance nodes of the pixel unit 10. At time t11, A/D conversion of the luminance signal Sab on each column of the first row ends. When the switch SCP is turned on, the digital luminance signal Sab is transferred from the synchronization column counter of the Sa signal column counter and Sab signal column counter to a horizontal transfer register. As the horizontal transfer register, a horizontal transfer register whose bit width is increased by operating the Sa signal register and the Sab signal register in synchronism with each other is used, thereby expanding the dynamic range of the image sensing signal.

During a period from time t12 to time t14, a 14-bit luminance signal Sab is sent from the synchronization horizontal transfer register to the DSP. At time t12, a readout operation starts for the second row of the pixel unit 10. During a period until time t14, A/D conversion is performed for the second row, thereby increasing the speed of the readout operation. The output circuit 16 outputs the digital image sensing signals. The above-described operation can improve the S/N by widening the dynamic range of the image sensor.

### Fourth Embodiment

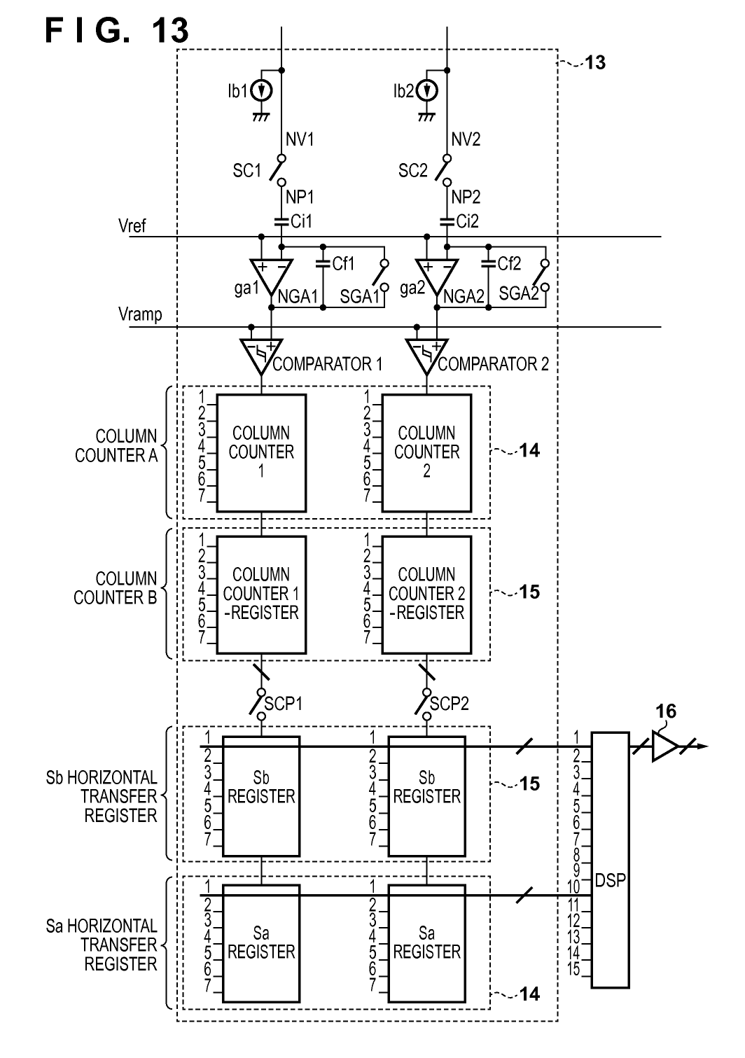

This embodiment is an example in which A/D conversion circuit arranged for each column signal line converts an image sensing signal and focus information signal into digital signals, and outputs them. The way of using counters and registers is different from that in the third embodiment. FIG. 13 is a circuit diagram showing a portion around a column-readout circuit 13 according to this embodiment. A common readout circuit 14 includes column counter A and an Sa signal horizontal transfer register. On the other hand, an image sensing signal readout circuit 15 includes column counter B and an Sab signal horizontal transfer register.

A timing chart in a first image sensing mode, that is, a mode in which both an image sensing signal and a focus information signal are read out within one horizontal scanning period according to this embodiment is the same as that shown in FIG. 11 of the third embodiment. An operation according to this embodiment will be described with reference to FIG. 11.

In this embodiment, during a period from time t7 to time t8, as a column counter when A/D-converting A focus information signals Sa on the first row of a pixel unit 10, column counter A shown in FIG. 13 is used by counting up. After A/D conversion of the A focus information signals Sa ends at time t8, the digital A focus information signals Sa accumulated in column counter A are copied to column counter B. At this time, column counter B is used as a register for storing the A focus information signals.

During a period from time t9 to time t11, A/D conversion is performed for luminance signals Sab on the first row of the pixel unit 10. At this time, A/D conversion is performed for the luminance signals Sab by counting down, in a direction opposite to that in the counting up, from the digital A focus information signals Sa accumulated in column counter A. This causes column counter A to perform subtraction processing “luminance signal Sab−A focus information signal Sa”, thereby accumulating a B focus information signal Sb in column counter A. In this embodiment, assume that column counters A and B are, for example, 7-bit counters.

At time t11, after A/D conversion of the luminance signals Sab ends, column counter B storing the A focus information signals Sa transfers a digital signal to the Sa signal horizontal transfer register, and column counter A storing the B focus information signals Sb transfers a digital signal to the Sb signal horizontal register. The A focus information signal Sa and B focus information signal Sb are used to perform focus detection. Furthermore, it is possible to obtain a luminance signal by adding the focus information signals.

A timing chart in a mode in which image sensing signals are read out within one horizontal scanning period, that is, a second image sensing mode according to this embodiment is the same as that shown in FIG. 12 of the third embodiment. When A/D-converting the luminance signals Sab during a period from time t7 to time t11, 7-bit column counter A and 7-bit column counter B are used as a 14-bit column counter by operating them in synchronism with each other. That is, in the second image sensing mode, when reading out an image sensing signal, column counter B as part of the common readout circuit 14 is used by connecting to column counter A in order to expand the dynamic range of the image sensing signal.

When performing a horizontal transfer operation during a period from time t12 to time t14, the 7-bit Sa horizontal transfer register and 7-bit Sb horizontal transfer register are used as a 14-bit external signal Sab horizontal transfer register by operating them in synchronization with each other. That is, when reading out only an image sensing signal, the Sa horizontal transfer register as part of the common readout circuit 14 is used to expand the dynamic range of the image sensing signal.

In the first image sensing mode, it is possible to nearly halve the signal amplitude to be processed by performing a subtraction operation between signals. If counters having the same bit width are used, it is possible to improve resolution capability at the time of A/D conversion, suppress quantization noise, and improve the S/N. This is also advantageous in data transfer since the bit width of a counter can be suppressed as compared with a case in which the added luminance signal Sab is A/D converted and output. In the second image sensing mode, it is possible to operate the counters in synchronism with each other, and keep the dynamic range of an image sensing signal wide.

### Other Embodiments

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-102592, filed May 14, 2013, which is hereby incorporated by reference herein in its entirety.

What is claimed is:

1. An image sensing apparatus comprising:
a pixel unit in which a plurality of pixels are arranged in a row direction and a column direction, each pixel including a first photoelectric conversion element, a second photoelectric conversion element, a charge-voltage converter, a transfer unit configured to transfer charges generated by the photoelectric conversion elements to the charge-voltage converter, and a reset unit configured to reset a voltage of the charge-voltage converter;
column signal lines configured to provide signals from the pixel unit to a processing unit;
the processing unit configured to process the signals from the pixel unit; and
a horizontal output line configured to output the signals from the processing unit,
the processing unit including a first capacitor and a second capacitor which are configured to hold a signal obtained by adding a signal of the first photoelectric conversion element and a signal of the second photoelectric conversion element, and provided via the column signal line,
wherein in a first image sensing mode, the processing unit holds an image sensing signal obtained by adding the signal of the first photoelectric conversion element and the signal of the second photoelectric conversion element in the second capacitor, and
in a second image sensing mode, the processing unit holds the added image sensing signal in a combined capacitance obtained by connecting the first capacitor and the second capacitor in parallel.

2. The apparatus according to claim 1, wherein
the processing unit further includes a third capacitor and a fourth capacitor,
in the first image sensing mode, the processing unit holds a voltage of the charge-voltage converter after reset, provided via the column signal line, in the third capacitor, and
in the second image sensing mode, the processing unit holds the voltage of the charge-voltage converter after reset, provided via the column signal line, in a combined capacitance obtained by connecting the third capacitor and the fourth capacitor in parallel.

3. The apparatus according to claim 2, wherein the third capacitor and the second capacitor have electrodes formed in the same shape.

4. The apparatus according to claim 1, wherein the processing unit further includes a third capacitor and a fourth capacitor,
in the first image sensing mode, the processing unit holds a voltage of the charge-voltage converter after reset, provided via the column signal line, in one of the third capacitor and the fourth capacitor, and
in the second image sensing mode, the processing unit holds the voltage of the charge-voltage converter after reset, provided via the column signal line, in a combined capacitance obtained by connecting the third capacitor and the fourth capacitor in parallel.

5. An image sensing apparatus comprising:
a pixel unit in which a plurality of pixels are arranged in a row direction and a column direction, each pixel including a first photoelectric conversion element, a second photoelectric conversion element, a charge-voltage converter, a transfer unit configured to transfer charges generated by the photoelectric conversion elements to the charge-voltage converter, and a reset unit configured to reset a voltage of the charge-voltage converter;
column signal lines configured to provide signals from the pixel unit to a processing unit; and
the processing unit configured to process the signals from the pixel unit;
wherein in a first image sensing mode, the processing unit A/D-converts the signal from the first photoelectric conversion element provided via the column signal line using a first counter, and A/D-converts the signal obtained by adding the signal from the first photoelectric conversion element and the signal from the second photoelectric conversion element provided via the column signal line using a second counter, and
in a second image sensing mode, the processing unit A/D-converts the added signal using a counter formed by series-connecting the first counter and the second counter.

6. The apparatus according to claim 5, further comprising
a subtraction processing unit configured to output a signal based on the second photoelectric conversion element by subtracting the signal from the first photoelectric conversion element from the image sensing signal, output from the processing unit.

7. The apparatus according to claim 5, wherein addition of the signal of the first photoelectric conversion element and the signal of the second photoelectric conversion element is performed by the charge-voltage converter.

8. An image sensing apparatus comprising:
a pixel unit in which a plurality of pixels are arranged in a row direction and a column direction, each pixel including a first photoelectric conversion element, a second photoelectric conversion element, a charge-voltage converter, a transfer unit configured to transfer charges generated by the photoelectric conversion elements to the charge-voltage converter, and a reset unit configured to reset a voltage of the charge-voltage converter;
column signal lines configured to provide signals from the pixel unit to a processing unit; and
the processing unit configured to process the signals from the pixel unit;
wherein in the first image sensing mode, after the processing unit A/D-converts the signal from the first photoelectric conversion element provided via the column signal line using a first counter, and stores a count value of the first counter in a second counter, the processing unit A/D-converts the signal obtained by adding the signal of the first photoelectric element and the signal of the second photoelectric element provided via the column signal line using the first counter from the count value in a direction opposite to that in the counting, and
in a second image sensing mode, the processing unit A/D-converts the added signal using a counter formed by series-connecting the first counter and the second counter.

9. The apparatus according to claim 8, wherein addition of the signal of the first photoelectric conversion element and the signal of the second photoelectric conversion element is performed by the charge-voltage converter.
